(19) United States
(12) Patent Application Publication
(10) Pub. No.: US 2021/0132106 A1
(43) Pub. Date: May 6, 2021

(54) EFFECTIVE ACCELEROMETER HAVING A REDUCED SIZE

(71) Applicant: COMMISSARIAT A L'ENERGIE ATOMIQUE ET AUX ENERGIES ALTERNATIVES, Paris (FR)

(72) Inventors: Martial DEFOORT, Grenoble Cedex 09 (FR); Marc SANSA PERNA, Grenoble Cedex 09 (FR); Sébastien HENTZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/087,805

(22) Filed: Nov. 3, 2020

(30) Foreign Application Priority Data
Nov. 6, 2019 (FR) 1912443

(51) Int. Cl. G01P 15/125; G01P 15/08

(52) U.S. Cl. CPC G01P 15/125; G01P 2015/0817; G01P 15/0802

(57) ABSTRACT

Microelectromechanical accelerometer comprising a support (2) and a mobile portion (4) able to be vibrated, means for measuring (10) the amplitude of the vibration of said mobile portion (4) in at least one detection direction of the plane of the accelerometer. The accelerometer comprises at least one foot (6) anchored on the support (2) by a first end and fixed to the mobile portion (4) by a second end, and allowing the mobile portion (4) to vibrate at least along said at least one detection direction under the effect of an acceleration force.

### TECHNICAL FIELD AND PRIOR ART

The present invention relates to an effective accelerometer having a reduced size.

An accelerometer comprises a suspended portion that is displaced under the action of a force undergone by the system to which the accelerometer is fixed. The displacement of the suspended portion is measured, which makes it possible to retrieve the acceleration undergone by the system. There are two types of accelerometers, static accelerometers of which the suspended portion is set into motion only due to the forces applied to the system, and dynamic accelerometers that are vibrated at their resonance frequency and of which the variation in the resonance frequency is measured and from this the force undergone by the system is deduced.

An accelerometer is comprised of a mobile portion of masse m, a spring with stiffness k and a damper that defines the losses of the system.

In the case of a static accelerometer, the latter is used up to its cut-off frequency which will depend on its resonance frequency. The resonance frequency is written:

ωᵣ [symbol] \sqrt{k/m}.

with k the stiffness.

However the gain of an accelerometer is inversely proportional to its resonance frequency. Consequently a compromise is sought between the bandwidth of the accelerometer and the gain. The gain and the bandwidth are controlled by the mass of the suspended portion and the stiffness of the accelerometer.

Consequently, it is desirable to be able to optimise the mass of the mobile portion and the stiffness of the means of suspension independently.

Moreover, it is desired to carry out accelerometers that have a reduced size, in particular for an application in smartphones.

The mobile portion and its mass define the sensitivity of the accelerometer. However, even by determining a minimum mass for a given application, the means of suspension of the mobile portion that extend laterally with respect to the mobile portion and the means of detection of the displacement of the mobile portion increase the size of the accelerometer and therefore the space it takes up. For example, in the case of an accelerometer with detection in the plane, the means of suspension are formed by springs that extend in the plane between the edges of the mobile portion and the substrate.

### DISCLOSURE OF THE INVENTION

It is consequently a purpose of the present invention to offer an effective accelerometer while having a reduced size.

The purpose announced hereinabove is reached by a linear accelerometer comprising a support, at least one mobile portion, the mobile portion being suspended from the support by means of at least one foot anchored to the support and being connected to the mobile portion on a zone of the latter facing the support. The means of detection of the displacement of the mobile portion are located at least partially under the mobile portion.

According to the invention, the mass of the mobile portion is mainly located at the level of the seismic mobile portion and the stiffness at the level of the foot or feet, which makes it possible to partially decouple the mass and the stiffness, and to modify the mass by acting little on the stiffness and inversely. The stiffness and the mass can then be fixed at least partially independently. Thus it is possible to more easily adjust the cut-off frequency and the gain. Furthermore, as the means of suspension do not extend in the plane of the mobile portion, a gain in space in the plane can be made.

It is possible to reduce the overall size of the sensor without reducing the mass and therefore without decreasing the resonance frequency of the system. Indeed, it is possible to retain the same mass and the same stiffness in a reduced space and thus not reduce the resonance frequency.

The accelerometer according to the invention has the advantage of having a reduced size with respect to the MEMS accelerometers of the prior art, while still having equivalent performance.

On the one hand, the structure of the accelerometer makes it possible to decouple the mobile portion of the resonance frequency of the structure, and to modify the resonance frequency by modifying the dimensions and the shape of the foot. On the other hand, the foot is fixed in the substrate under the structure, in such a way that the entire surface occupied by the accelerometer corresponds to the mobile portion. The geometry of the foot can be modified without affecting the space taken by the accelerometer. For example, it is possible to carry out feet with an asymmetric shape so as to favour a detection axis. Furthermore the shape of the foot or of the feet can be modified without modifying the shape of the mobile portion.

By decoupling the mobile portion and the means of suspension thereof, it is possible to dimension the accelerometer so that it occupies a small surface while still being able to control the resonance frequency of the MEMS according to the target applications.

According to an example, at least one portion of the detection means is located under the mass in such a way that they directly detect the vibrations of the mobile portion, between the foot and the support. This can be capacitive means, piezoelectric means or very advantageously optomechanical means.

In other terms, the means of suspension are carried out in a plane different from the plane wherein the mobile portion is intended to be displaced, as well as the detection means, which makes it possible to reduce the size of the sensor.

The present invention applies to both static accelerometers and to dynamic accelerometers. In the latter case, the excitation means and the detection means are located at the level of the foot in such a way that the surface occupied by gyro is equal to the surface of the mobile portion.

One of the subject-matters of the present application is then a microelectromechanical accelerometer comprising a support and a mobile portion able to be vibrated with respect to the support, means for measuring the amplitude of the vibration of said mobile portion in at least one detection direction contained in the plane of the accelerometer, the accelerometer comprising at least one foot anchored on the support by a first end and fixed to the mobile portion by a second end, and allowing the mobile portion to vibrate at least along said at least one detection direction under the effect of an acceleration force, said means for measuring being located at least partially under the mobile portion.

Another subject-matter of the present application is a system for measuring an acceleration comprising a plurality of accelerometers according to the invention, each mobile portion comprising at least two edges in the plane of the system, each one of the edges directly facing an edge of a mobile portion of an adjacent accelerometer.

### BRIEF DESCRIPTION OF THE DRAWINGS

The present invention shall be better understood based on the following description and accompanying drawings wherein:

FIG. 1A diagrammatically shows in perspective an embodiment of an accelerometer according to the invention,

FIG. 1B is a side view of the accelerometer of FIG. 1A the mobile portion being in movement,

FIG. 2 diagrammatically shows a top view of another embodiment of an accelerometer according to the invention,

FIGS. 3A and 3B diagrammatically show perspective views of other embodiments of an accelerometer according to the invention,

FIG. 4 diagrammatically shows a top view of another embodiment of an accelerometer according to the invention comprising two feet,

FIG. 5 diagrammatically shows a top view of an example of a network of accelerometers according to the invention,

FIG. 6A is a diagrammatically shown top view of an example of an accelerometer with capacitive detection means,

FIG. 6B is a diagrammatically shown top view of another example of an accelerometer with capacitive detection means,

FIG. 7 is a diagrammatically shown top view of an example of an accelerometer with piezoresistive detection means,

FIG. 8 is a diagrammatically shown top view of an example of an accelerometer with optomechanical detection means,

FIGS. 9A to 9G diagrammatically show elements obtained during various steps of an example of a method for carrying out an accelerometer according to the invention.

### DETAILED DISCLOSURE OF PARTICULAR EMBODIMENTS

The accelerometer is a microelectromechanical system (MEMS) and/or nanoelectromechanical system (NEMS). In what follows a microelectromechanical system designates a microelectromechanical and/or nanoelectromechanical system.

The linear accelerometer according to the invention is capable of determining at least one acceleration in a direction in the plane. In particular embodiments, it makes it possible to determine accelerations in two directions in the plane of the accelerometer.

“Plane of the accelerometer” means the average plane of the latter that is parallel to the support. The support of the accelerometer is formed by the substrate used for the manufacturing by microelectronic techniques.

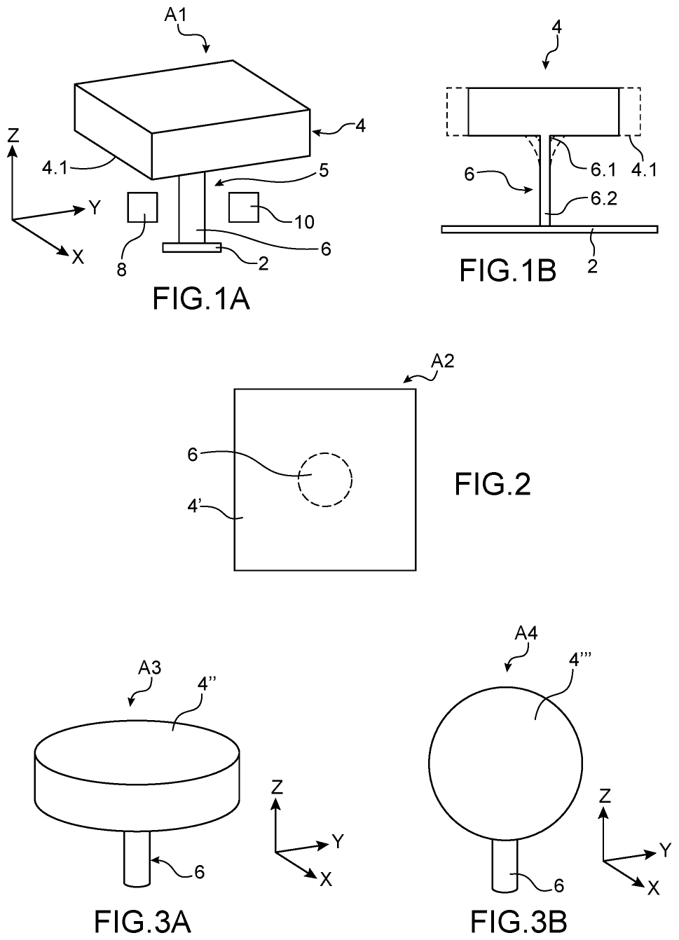

In FIGS. 1A and 1B, an example of an accelerometer A1 can be seen.

The accelerometer A1 comprises a support 2, a mobile portion 4 and means of suspension 5 of the mobile portion 4. The mobile portion 4 is displaced mainly in the plane XY of the accelerometer.

In this embodiment, the means of suspension 5 comprise a foot 6 anchored on the support by a first longitudinal end 6.1 and fixed to the mobile portion 4 by a second longitudinal end 6.2. The foot is fixed to the mobile portion 4 at the level of a face 4.1 of the latter facing the support 2.

In the example shown, the mobile portion 4 has the shape of a rectangle parallelepiped, with one of the larger surface faces facing the substrate, and the foot extends longitudinally in a direction Z orthogonal to the plane XY. Furthermore the sides of the larger dimension extend in the direction Y.

In this example, the foot has a circular section in the plane XY and is of a constant section along the direction Z.

The foot 6 is such that it is able to be deformed in flexion in order to allow the mobile portion to be displaced and vibrate in the plane XY, at least under the action of an external force.

FIG. 1B diagrammatically shows a vibration mode of the resonator of FIG. 1A, which substantially takes place in the plane XY. It will be understood that, since the foot is deformed in flexion and is not extended, the mobile portion has an out-of-plane displacement, but the latter is very low, it is not detected and does not disturb the measurement of the displacement in the plane of the mobile portion.

Thanks to the invention, the rigidity is mainly adjusted by the characteristics of the foot, while the mass of the accelerometer is mainly set by the dimensions of the mobile portion.

The mobile portion and the foot are configured to form a resonator that has at least one vibration mode in the direction of the acceleration that is sought to be determined.

In this example, the accelerometer is such that it favours an axis of vibration, so as to reduce the coupling with the other modes and the noise that results therefrom.

In the example shown, the mobile portion of rectangular shape oriented in the direction Y forms a resonator that favours the vibration axis Y.

Preferably, the mobile portion and the foot have at least one axis of symmetry in the plane XY, the accelerometer being oriented so that the direction of the acceleration or accelerations to be determined are aligned with the axis or axes of symmetry of the mobile portion.

The foot is fixed to the centre of the face of the mobile portion facing the support. In FIG. 1A, the foot 6 is fixed to the mobile portion at the point of intersection of the diagonals of the face of the mobile portion.

In the example of FIG. 2, the accelerometer A2 comprises a mobile portion 4′ in the shape of a parallelepiped with a square section (in the plane of the sensor) and a foot 6 with a circular section, the accelerometer makes it possible to determine the accelerations in the directions X and Y with the same sensitivity.

Alternatively, the mobile portion is cubic, rectangular or hexagonal prismatic.

In another example, the mobile portion and the foot have a central symmetry with respect to the out-of-plane direction. For example, the accelerometer A3 comprises a mobile portion 4″ that has a cylindrical revolution shape about the axis Z (FIG. 3A) and the accelerometer A4 comprises a mobile portion with a spherical shape 4′″ (FIG. 3B). The accelerometers A3 and A4 make it possible to determine the accelerations in all the directions of the plane XY.

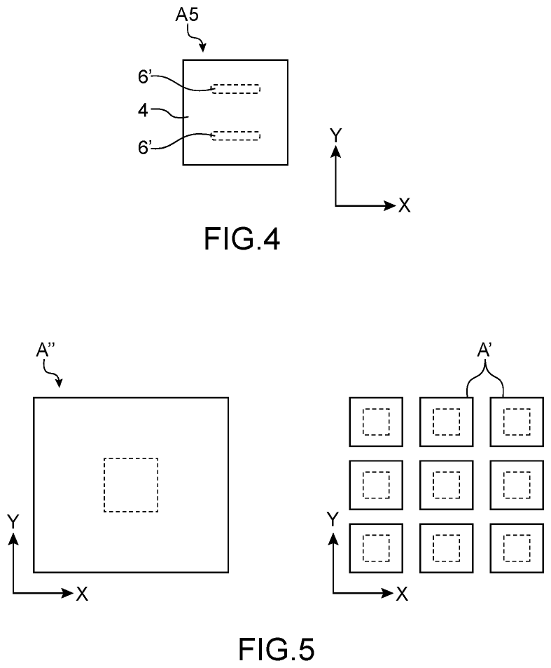

In FIG. 4, another example of the structure of an accelerometer A5 comprising two feet can be seen.

The two feet have rectangular sections in the plane XY and their length is oriented in the direction X. The two feet 6′ are parallel. This shape of the feet and their orientation favour the detection along the direction Y wherein the feet have a greater flexibility on the direction Y with respect to the direction X.

Preferably the total surface of the section of the single foot or of the feet is less than or equal to 10% of the surface of the mobile portion, which makes it possible to carry out a structure that is little rigid.

For example, the mobile portion has a surface between 1 μm×1 μm up to 500 μm×500 μm, and a thickness between 1 μm and 500 μm. The total surface of the section of the foot or feet supporting the mobile portion is less than the surface of the mobile portion in the plane of the accelerometer. The section of each foot can be between 50 nm×50 nm and 100 μm×100 μm. The length of the feet is preferably at least equal to its lateral dimensions, and it can be between 50 nm and 100 μm.

Furthermore the foot or feet and the mobile portion can be made from the same material or in different materials, making it possible to choose materials that optimise the functions of the foot or feet and of the mobile portion. For example, the mobile portion can be made from a material that has a high density so as to maximise the mass and therefore the effect of the forces of acceleration on the mobile portion. For example, silicon which has a density of 2,300 kg/m³ is chosen or tantalum, which has a density of 16,690 kg/m³.

Advantageously, the foot or feet are made from a rigid material, i.e. that has a high Young's modulus, of more than 100 GPa. Furthermore, advantageously it is an isotropic material, for example crystalline, in such a way as to offer the same behaviour in the direction of excitation and in the detection direction. For example, silicon is chosen, which is a crystalline material with a Young's modulus of 130-188 GPa.

The support, the foot or feet and the mobile portion can be made from the same material or different materials.

The accelerometer also comprises means for measuring the amplitude of at least one of its vibration modes.

These means for measuring measure the displacement of the mobile portion.

FIG. 6A shows an example of an accelerometer according to the invention implementing means for measuring 10, which are of the capacitive type. In this example, they comprise an electrode 22 arranged in the vicinity of the mobile portion 4′ in such a way that the distance between the mobile portion 4′ and the electrode 22 varies when the mobile portion 4′ is displaced in the detection direction Y. It is assumed that the mobile portion 4′ is electrically conductive and directly forms the other electrode. Otherwise an electrically-conductive layer is carried out in order to form the other electrode. The mobile portion and the electrode are separated by air or a vacuum forming a dielectric, and form a capacitor of which the capacitance varies with the displacement of the mobile portion along the direction Y. The electrode or the mobile portion is polarised, for example at 0 V. The vibration of the mobile portion due to the forces of acceleration in the direction Y, causes a variation in the capacitance of the capacitor, and creates a current that is proportional to the amplitude of the vibration of the mobile portion through the electrode. The detection means comprise means for measuring this current, for example a transimpedance amplifier and a spectrum analyser. From this current, it is possible to retrieve the acceleration undergone by the system to which the accelerometer is fixed. The electrode is located at least partially under the mobile portion, which reduces the size of the accelerometer. In the example of FIG. 6A, the electrode 22 is facing the foot 6 and it is a variation in the air gap that is measured. In another example the electrode 22 is facing the lower face of the mobile portion 4′, a surface variation (FIG. 6B) is then measured.

Several electrodes can be implemented, for example to take a differential measurement. For this, at least one first electrode is arranged facing the foot and another second electrode is arranged facing the foot opposite the first electrode with respect to the foot, with the first and second electrodes being aligned along the detection direction. Thus, when the mobile portion vibrates, the foot also vibrates and the capacitances of the capacitors vary inversely, allowing for a differential measurement.

The capacitive means for measuring are particularly adapted to accelerometers intended to detect small accelerations.

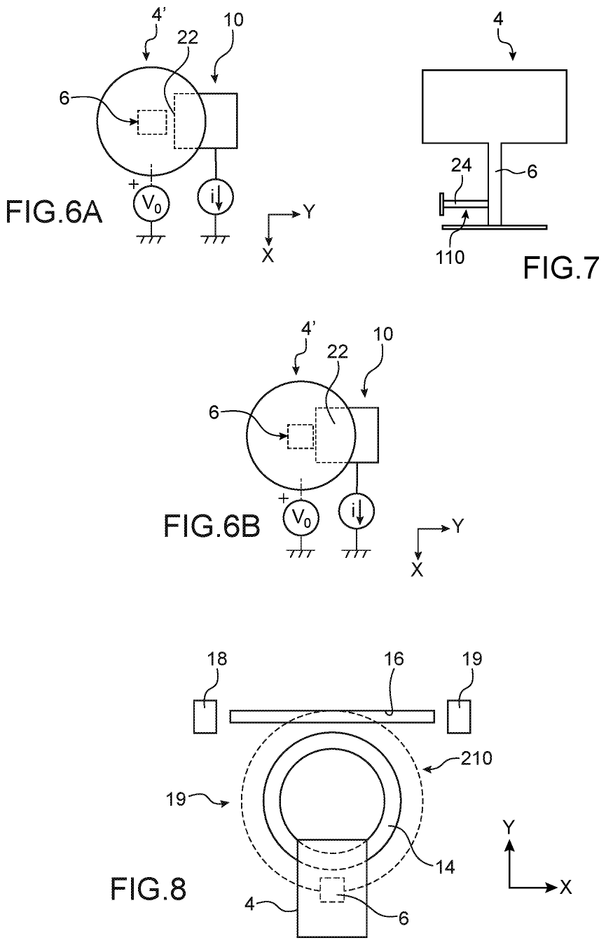

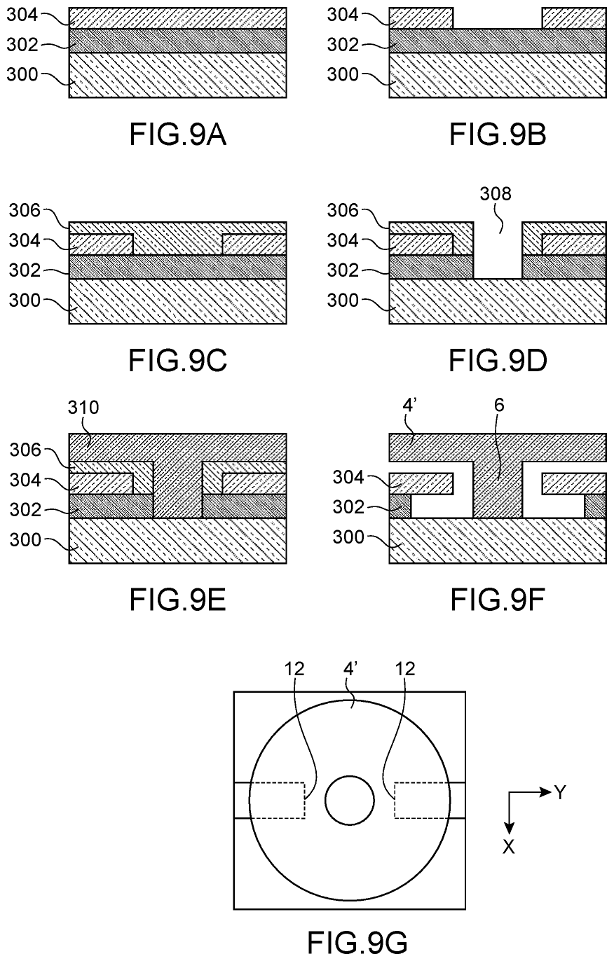

In another embodiment shown in FIG. 7, the detection means 110 are of the piezoresistive type. For example the detection means comprise a beam 24 made of a piezoresistive material suspended between the substrate and the foot or between the substrate and the mobile portion, a constant voltage is applied to the beam 24, the compression and the extension undergone by the beam cause a variation in the electrical resistance of the beam. The output current is then proportional to the resistance of the gauges, which varies at the vibration frequency of the resonator. Several piezoresistive beams can be implemented, for example to take a differential measurement. The foot can be used to conduct the current or a conductor track is formed along the foot.

The beams can be made of piezoresistive and/or piezoelectric materials. The piezoresistive and/or piezoelectric means for measuring are particular suited for measuring strong accelerations.

Implementing beams between the foot and the substrate makes it possible to limit the size of the accelerometer, an advantageous example can be seen of an accelerometer according to the invention seen from above.

In this example the detection means are of the optomechanical type.

The detection means 210 comprise an optical resonator 14, in this example a ring arranged in relation to the foot of the accelerometer in such a way that it is displaced in the evanescent field (symbolised by the circle in a dotted line) of the ring, which is typically of about several hundred nanometres for a light with a wavelength of 1,550 nm. In this example the foot is located at a distance between 50 nm and 200 nm from the edge of the ring. They also comprise a waveguide 16 located in the vicinity of the ring, and intended to inject an input light signal into the resonator and to retrieve an output light signal. A source 18 generates the light signal in the waveguide, for example at an end of the waveguide and a detector 19, for example at the other end of the waveguide, collects the output light signal from the ring.

The mobile portion is set into motion along the direction Y, under the effect of the forces of acceleration in the evanescent field of the ring, which has for effect to vibrate the foot and to modify the optical properties of the optical resonator, and in particular its optical resonance frequency, this results in a modulation of the intensity of the light proportional to the movement of the mobile portion. For example, the detector uses spectrometric techniques, it is possible to detect this modulation of intensity of the output light signal. Using these measurements, it is possible to retrieve the acceleration.

As a variant, a waveguide for the input light signal and a waveguide to collect the output light signal are implemented.

In another example, an optical resonator is implemented to detect the displacements along Y of several mechanical resonators, for example the mobile portions are arranged around the ring in the evanescent field of the latter. In this case, multiplexing techniques, for example time multiplexing or resonance frequency multiplexing, are set up to distinguish the displacement of each mobile portion.

Alternatively, the ring is replaced with an optical disc.

In another example of optical detection, the movement of the resonator is measured with interferometric techniques. In this case, a laser light source is separated into two different paths, one of the paths containing the optical resonator and the resonant MEMS and the other acting as a reference path. When the MEMS varies the optical resonance frequency, it also modulates the phase of the light at the output of the resonator. When the light at the output of the resonator is combined with the reference path, the interference between the two signals causes a modulation of the intensity of the output light that is proportional to the movement of the MEMS.

Implementing optomechanical detection means makes it possible to improve the performance of the accelerometer with respect to electrical detection means. Indeed they make it possible to precisely measure the movement of smaller masses, and therefore to reach a bandwidth that is higher than that that can be reached by electrical detection means.

The examples described hereinabove are static accelerometers, of which the mobile portion is set into motion only by the forces of acceleration. The invention also applies to accelerometers that operate at the resonance for which the mobile portion is vibrated at its resonance frequency and the variation of the resonance frequency following the acceleration is measured, which makes it possible to determine the acceleration. The resonance frequency of the mobile portion is that of the mobile portion and foot unit.

The resonant accelerometer comprises excitation means for exciting in vibration the mobile portion, for example this is electrostatic means that act directly on the mobile portion, or thermal means that act for example on the foot or feet.

In an embodiment, the excitation means comprise at least one electrode carried by the support and an electrode carried or formed by the foot or the mobile portion, in such a way as to apply an electrostatic force to the foot or to the mobile portion in the first direction.

In another embodiment, the excitation means comprise at least one beam made of a piezoelectric material suspended between the substrate and the foot, oriented in such a way as to apply a mechanical force to the foot in the first direction. When the means for measuring the amplitude of vibration comprise piezoelectric or piezoresistive beams, the same beam can be used for the actuation in a direction and for the detection in this direction, preferably the beam is parallel to this direction. At least one beam is provided for the excitation in one direction and a beam is provided for the detection in another direction. For example a beam parallel to the direction X is used for the excitation and for the detection in the direction X and a beam is used for the excitation and for the detection in the direction Y. Thus with two beams a two-axis accelerometer is carried out.

Examples of dimensions of the mobile portion and of the pillars for different structures and their resonance frequency shall now be given. These examples are in no way limiting.

Take an accelerometer according to the example of FIG. 3A, the foot has a section in the plane XY of diameter 1 μm and a length along the axis Z of 2 μm. The mobile portion of cylindrical shape has a diameter of 5 μm and a thickness of 3 μm. The structure has an infinity of favoured vibration directions in the plane YX, all at a resonance frequency of 9 MHz. This accelerometer can be a static accelerometer or a resonant accelerometer.

Take an accelerometer comprising two cylindrical feet and a mobile portion in the shape of a square prism. The feet are attached to the mobile portion at the level of the perpendicular bisector orthogonal to the direction of detection, symmetrically with respect to the detection direction. The sides of the mobile portion have a section of 5 μm on the side and a thickness 3 μm. The feet have a section of diameter 1 μm and a length of 2 μm, separated by a distance of 3 μm between the axes of the feet. The structure has a privileged vibration direction, of which the resonance frequency is 11 MHz, while the perpendicular axis has a resonance frequency of 37 MHz, reducing by one order of magnitude its detection facing the privileged axis. This accelerometer can be a static accelerometer or a resonant accelerometer.

In FIG. 5, an example of a network of accelerometers A′ can be seen. The accelerometers A′, numbering 9 in the example shown, are distributed into lines and columns. Their shape is identical to that of the accelerometer of FIG. 1A. The total surface of this network of nine small accelerometers A′ is identical to that of a single accelerometer A″ shown on the left in FIG. 5 with a very close mass.

Thanks to the structure of the accelerometers according to the invention, the mobile portions of the accelerometers A′ are arranged next to one another with at least two of the lateral faces directly facing lateral faces of the adjacent accelerometers, no means of suspension are interposed between the accelerometers. The density of the accelerometers can then be substantial. Other arrangements and shapes of mobile portions can be considered.

In an advantageous example where the stiffness of the accelerometers is close to or identical to that of the single sensor, the sum of the gains of the accelerometers is close to the gain of the single sensor. However the thermomechanical noise of the network and therefore the signal-to-noise ratio is reduced by a factor √N, N being the number of sensors. The resonance frequency and also the cut-off frequency are increased by a factor √N, which is advantageous for accelerometers dedicated to strong accelerations.

Thanks to the structure of the accelerometers according to the invention, it is therefore possible to carry out a matrix that combines identical resonators, of small size for example 1 μm×1 μm, while still forming a total structure that has external dimensions for example of 500 μm×500 μm.

Alternatively, it is possible to carry out a network of N accelerometers that has the same resonance frequency as a single large accelerometer and supplying an increased output signal with respect to that of the large accelerometer.

The N sensors can all be sensitive to the same direction, for example the direction X, or be sensitive to different directions from one another allowing for the detection of the accelerations in both directions. For example N/2 sensors are sensitive to the direction X and N/2 sensors are sensitive to the direction Y.

Furthermore, as explained hereinbelow the accelerometers can be adapted to detect small accelerations or strong accelerations. The sensors can comprise means for measuring that are different from each other.

A network of accelerometers of small size can make it possible to measure several directions of acceleration and/or several intensities of acceleration, while still not having a size greater than an accelerometer of the prior art.

The means for measuring of each accelerometer can be independent from one another. Advantageously, the signals of the means for measuring and optionally those of the excitation means are multiplexed, so as to reduce the connections and the size of the means for measuring.

For example, in the case of optical detection means, a disc or an optical ring associated with each mobile portion is provided and a single waveguide injects an input light signal in all the discs and retrieves all the output light signals.

In the case of means for measuring of the capacitive type or of the piezoelectric type, it is possible to consider carrying out accelerometers in such a way that they have different vibration amplitudes.

In the case of resonant accelerometers, their resonance frequencies can be different.

The accelerometer according to the invention is particularly suited for an arrangement in lines and in columns due to the reduced space taken up.

Furthermore, the structure of the accelerometer according to the invention is advantageously compatible with an optomechanical method of detection. As this method of detection performs particularly well, it is possible to increase the bandwidth of the sensor, i.e. it is possible to reduce its size or increase its rigidity, with no loss of performance.

An example of a method for carrying out an accelerometer according to the invention shall now be described.

Using a Silicon On Insulator (SOI) wafer (FIG. 9A), comprising a substrate made of silicon 300, a layer made of SiO₂ 302 and a layer of monocrystalline silicon 304; the layer 304 is structured to form the electrodes, for example by photolithography and etching.

The element thus obtained is shown in FIG. 9B.

During a following step a sacrificial layer 306 is formed, for example made of SiO₂, for example by deposition, for example, by chemical vapour deposition, or by oxidation.

The element thus obtained is shown in FIG. 9C

During a following step, the sacrificial layer 306 is structured to form the foot, for this a cavity 308 is carried out opening onto the substrate 300, for example by photolithography and etching.

The element thus obtained is shown in FIG. 9D.

During a following step, in the cavity 308 and on the superficial layer 306 a layer of semiconductor material 310 is formed, for example amorphous silicon. The layer 310 is for example formed by deposition, for example by chemical vapour deposition. The thickness of the layer 310 on the superficial layer 306 is advantageously that of the mobile portion that is sought to be carried out.

The element thus obtained is shown in FIG. 9E.

During a following step, the layer 310 is structured to delimit the mobile portion. Trenches openings onto the superficial layer 306 are formed delimiting the outer edge of the mobile portion. This structuring is for example carried out by photolithography and etching, for example a reactive ionic etching or a liquid phase KOH etching.

During a following step, the mobile portion 4′ and its foot 6 are released by etching the superficial layer 306 and the layer of SiO₂ 302, for example by wet etching for example with hydrofluoric acid. The etching distance is chosen in such a way that the electrodes at the level of the foot are not completely released.

The element thus obtained is shown in FIG. 9F.

The element is also shown in FIG. 9G (top view). It can be seen that simultaneously the substrate was structured to carry out electrodes facing the foot aligned with the direction Y, for example to form means for measuring the displacement of the mobile portion.

In another embodiment, the layer 310 made of amorphous silicon is rendered conductive, for example by doping and heat treatment, for example to use the mass in the detection of the displacement.

In another embodiment, an additional layer is formed on the layer 310, for example made from a material that has a high density for example tungsten, to increase the mass of the mobile portion and thus improve the performance of the accelerometer.

The various embodiments can be combined: the different shapes of the mobile portion, the different shapes and/or the number of feet supporting the mobile portion and/or the means for measuring can be combined.

1. Microelectromechanical accelerometer comprising a support and a mobile portion able to be vibrated with respect to the support, at least one sensor for measuring the amplitude of the vibration of said mobile portion in at least one detection direction contained in the plane of the accelerometer, the accelerometer comprising at least one foot anchored on the support by a first end and fixed to the mobile portion by a second end, and configured to allow the mobile portion to vibrate at least along said at least one detection direction under the effect of an acceleration force, said at least one sensor being located at least partially under the mobile portion.

2. Microelectromechanical accelerometer according to claim 1, wherein the at least one foot has a section in the plane of the accelerometer less than the surface of the mobile portion in the plane of the accelerometer.

3. Microelectromechanical accelerometer according to claim 1, comprising the at least one foot comprise several feet anchored on the support by a first end and fixed to the mobile portion by a second end, and wherein the sum of the sections of the feet in the plane of the accelerometer is less than the surface of the mobile portion in the plane of the accelerometer.

4. Microelectromechanical accelerometer according to claim 2, wherein the surface of the section of the at least one foot is less than or equal to 10% of the surface of the mobile portion.

5. Microelectromechanical accelerometer according to claim 1, wherein the mobile portion and/or the at least one foot have a shape that favours at least one vibration direction of the mobile portion corresponding to the at least one detection direction.

6. Microelectromechanical accelerometer according to claim 1, wherein the at least one foot has a circular or square section in the plane of the accelerometer.

7. Microelectromechanical accelerometer according to claim 5, wherein the section of the at least one foot in the plane of the accelerometer has a smaller dimension in the detection direction with respect to the dimension in a direction orthogonal to the detection direction.

8. Microelectromechanical accelerometer according to claim 1, wherein the mobile portion has a square shape in the plane of the accelerometer or cylindrical revolution with an axis normal to the plane of the accelerometer and wherein the accelerometer has two detection axes.

9. Microelectromechanical accelerometer according to claim 1, comprising an excitation device configured to vibrate the mobile portion at its resonance frequency, and wherein the at least one sensor is configured to measure a variation in the resonance frequency.

10. Microelectromechanical accelerometer according to claim 1, wherein the at least one sensor comprises an optical resonator arranged with respect to the mobile portion in such a way that the mobile portion is located at least partially in the evanescent field of the optical resonator at least in the detection direction, at least one injector for injecting a light signal into the resonator and at least one collector for collecting a light signal coming from the optical resonator.

11. Microelectromechanical accelerometer according to claim 1, wherein the at least one sensor is a capacitive sensor comprising at least one electrode carried by the mobile portion and an electrode carried by the support.

12. Microelectromechanical accelerometer according to claim 1, wherein the at least one sensor is a piezoelectric and/or piezoresistive sensor comprising at least one suspended beam between the foot and the support.

13. Microelectromechanical accelerometer according to claim 1, wherein the mobile portion comprises at least one material having a high density, and the at least one foot is made of a rigid material.

14. Microelectromechanical accelerometer according to claim 3, wherein the sum of the surfaces of the sections of the feet in the plane of the accelerometer is less than or equal to 10% of the surface of the mobile portion.

15. System for measuring an acceleration comprising a plurality of microelectromechanical accelerometers according to claim 1, each mobile portion comprising at least two edges in the plane of the system, each one of the edges directly facing an edge of a mobile portion of an adjacent microelectromechanical accelerometers.
